(19) United States
(12) Patent Application Publication
(10) Pub. No.: US 2010/0088301 A1
(43) Pub. Date: Apr. 8, 2010

(54) SYNCHRONIZATION OF UDDI REGISTRIES AND SERVICE REGISTRIES

(76) Inventors: Yi San Zhao, Beijing (CN); John Colgrave, Chandlers Ford (GB); Xiaoqiang Hou, Beijing (CN); Bernard Zdzislaw Kufluk, Southampton (GB); Dan Xia, Beijing (CN); Pu Zhu, Beijing (CN)

Correspondence Address: HOLLAND & KNIGHT LLP, 10 ST. JAMES AVENUE, BOSTON, MA, 02116, US

(21) Appl. No.: 12/244,217

(22) Filed: Oct. 2, 2008

(51) Int. Cl. G06F 7/06; G06F 17/30

(52) U.S. Cl. 707/706; 707/E17.014; 707/E17.005; 707/E17.044

(57) ABSTRACT

A first UDDI registry is queried for at least one entity contained within the first UDDI registry. At least one attribute of the at least one entity contained within the first UDDI registry is compared with an entity attribute record associated with a service registry. If the at least one attribute of the at least one entity contained within the first UDDI registry is different from the entity attribute record associated with the service registry, an updated entity attribute record is generated based upon, at least in part, a difference between the at least one attribute and the entity attribute record.

### TECHNICAL FIELD

This disclosure generally relates to service registries, and more particularly to synchronizing service registries and Universal Description, Discovery and Integration registries.

### BACKGROUND

Universal Description, Discovery and Integration (“UDDI”) is a platform-independent, xml-based registry for businesses worldwide to register service definitions. UDDI systems generally provide a directory of services that are available, which may generally be akin to the yellow pages of a telephone book. As such, UDDI systems only provide a listing of the services, without actually taking ownership of the service documents referenced by the registry listings. Increasingly, other registry products are being developed that not only provide a directory of services, but also provide repository functionality that may take ownership of service documents and/or other artifacts associated with the services, as well as various other features. Conversion from UDDI registries to other such service registry products, as well as co-deployment of UDDI registries and other service registry products presents difficulties arising from inherent limitations in the UDDI framework.

### SUMMARY OF THE DISCLOSURE

According to a first implementation a method includes querying a first UDDI registry for at least one entity contained within the first UDDI registry. At least one attribute of the at least one entity contained within the first UDDI registry is compared with an entity attribute record associated with a service registry. If the at least one attribute of the at least one entity contained within the first UDDI registry is different from the entity attribute record associated with the service registry, an updated entity attribute record is generated based upon, at least in part, a difference between the at least one attribute and the entity attribute record.

One or more of the following features may be included. The at least one attribute of the at least one entity contained within the first UDDI registry may include a time of last modification. Similarly, the entity attribute record may include a time of last modification of a corresponding entity contained within the service registry. Further, the method may also include calculating a server time differential between a time of last modification of the at least one entity contained within the first UDDI registry and a time of last modification of the corresponding entity contained within the service registry. The at least one attribute may include a property of the at least one entity contained within the first UDDI registry, and the entity attribute record may include a property of a corresponding entity contained within the service registry. An updated attribute record may be propagated to at least a second UDDI registry.

The method may also include querying a second UDDI registry for at least one entity contained within a second UDDI registry. At least one attribute of the at least one entity contained within the second UDDI registry may be compared to at least one attribute of the at least one entity contained within the first UDDI registry. If the at least one attribute of the at least one entity contained within the second UDDI registry differs from the at least one attribute of the at least one entity contained within the first UDDI registry, one of the at least one entity contained within the second UDDI registry and the at least one entity contained within the first UDDI registry may be selected based upon, at least in part, a predefined policy.

At least one document referenced by the at least one entity contained within the first UDDI registry may be retrieved. The at least one document may be stored within the service registry.

According to another implementation, a computer program product includes a computer readable medium having a plurality of instructions stored on it. When executed by a processor, the instructions may cause the processor to perform operations including querying a first UDDI registry for at least one entity contained within the first UDDI registry. At least one attribute of the at least one entity contained within the first UDDI registry is compared with an entity attribute record associated with a service registry. If the at least one attribute of the at least one entity contained within the first UDDI registry is different from the entity attribute record associated with the service registry, an updated entity attribute record is generated based upon, at least in part, a difference between the at least one attribute and the entity attribute record.

One or more of the following features may be included. The at least one attribute of the at least one entity contained within the first UDDI registry may include a time of last modification. The entity attribute record may also include a time of last modification of a corresponding entity contained within the service registry. The computer program product may also include instructions for calculating a server time differential between a time of last modification of the at least one entity contained within the first UDDI registry and a time of last modification of the corresponding entity contained within the service registry. The at least one attribute may include a property of the at least one entity contained within the first UDDI registry. Similarly, the entity attribute record may include a property of a corresponding entity contained within the service registry. Instructions may be included for propagating the updated attribute record to at least a second UDDI registry.

Instructions may be included for querying a second UDDI registry for at least one entity contained within a second UDDI registry. At least one attribute of the at least one entity contained within the second UDDI registry may be compared to at least one attribute of the at least one entity contained within the first UDDI registry. If the at least one attribute of the at least one entity contained within the second UDDI registry differs from the at least one attribute of the at least one entity contained within the first UDDI registry, one of the at least one entity contained within the second UDDI registry and the at least one entity contained within the first UDDI registry may be selected based upon, at least in part, a predefined policy.

Instructions may be included for retrieving at least one document referenced by the at least one entity contained within the first UDDI registry. The at least one document may be stored within the service registry.

According to yet another implementation, a computing system includes at least one processor and at least one memory architecture coupled with the at least one processor. A first software module, which is executed on the at least one processor and the at least one memory architecture, is configured to query a first UDDI registry for at least one entity contained within the first UDDI registry. A second software module is executed on the at least one processor and the at least one memory architecture. The second software module is configured to compare at least one attribute of the at least one entity contained within the first UDDI registry with an entity attribute record associated with a service registry. A third software module is executed on the at least one processor and the at least one memory architecture. If the at least one attribute of the at least one entity contained within the first UDDI registry is different from the entity attribute record associated with the service registry, the third software module is configured to generate an updated entity attribute record based upon, at least in part, a difference between the at least one attribute and the entity attribute record.

One or more of the following features may be included. The at least one attribute of the at least one entity contained within the first UDDI registry may include a time of last modification, and the entity attribute record may include a time of last modification of a corresponding entity contained within the service registry. The at least one attribute may include a property of the at least one entity contained within the first UDDI registry, and the entity attribute record may include a property of a corresponding entity contained within the service registry. A fourth software module, which may be executed on the at least one processor and the at least one memory architecture, may be configured to propagate the updated attribute record to at least a second UDDI registry.

The computing system may further include a fifth software module that may be executed on the at least one processor and the at least one memory architecture. The fifth software module may be configured to query a second UDDI registry for at least one entity contained within a second UDDI registry. A sixth software module may be executed on the at least one processor and the at least one memory architecture, and may be configured to compare at least one attribute of the at least one entity contained within the second UDDI registry to at least one attribute of the at least one entity contained within the first UDDI registry. A seventh software module may be executed on the at least one processor and the at least one memory architecture. If the at least one attribute of the at least one entity contained within the second UDDI registry differs from the at least one attribute of the at least one entity contained within the first UDDI registry, the seventh software module may be configured to select one of the at least one entity contained within the second UDDI registry and the at least one entity contained within the first UDDI registry based upon, at least in part, a predefined policy.

An eighth software module may be executed on the at least one processor and the at least one memory architecture, and may be configured to retrieve at least one document referenced by the at least one entity contained within the first UDDI registry. A ninth software module, which may be executed on the at least one processor and the at least one memory architecture, may be configured to store the at least one document within the service registry.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a synchronization process, a service registry and a UDDI registry coupled to a distributed computing network;

FIG. 2 is a flowchart of a process executed by the synchronization process of FIG. 1;

FIG. 3 diagrammatically depicts a comparison of a time of last modification of entities contained within the UDDI registry to entities contained within the service registry of FIG. 1;

FIG. 4 diagrammatically depicts a server time differential calculation;

FIG. 5 diagrammatically depicts a comparison of attributes of an entity contained within the UDDI registry to attributes of a corresponding entity contained within the service registry of FIG. 1; and

FIG. 6 diagrammatically depicts a schema for conflict resolution between multiple UDDI registries of FIG. 1.

### DETAILED DESCRIPTION

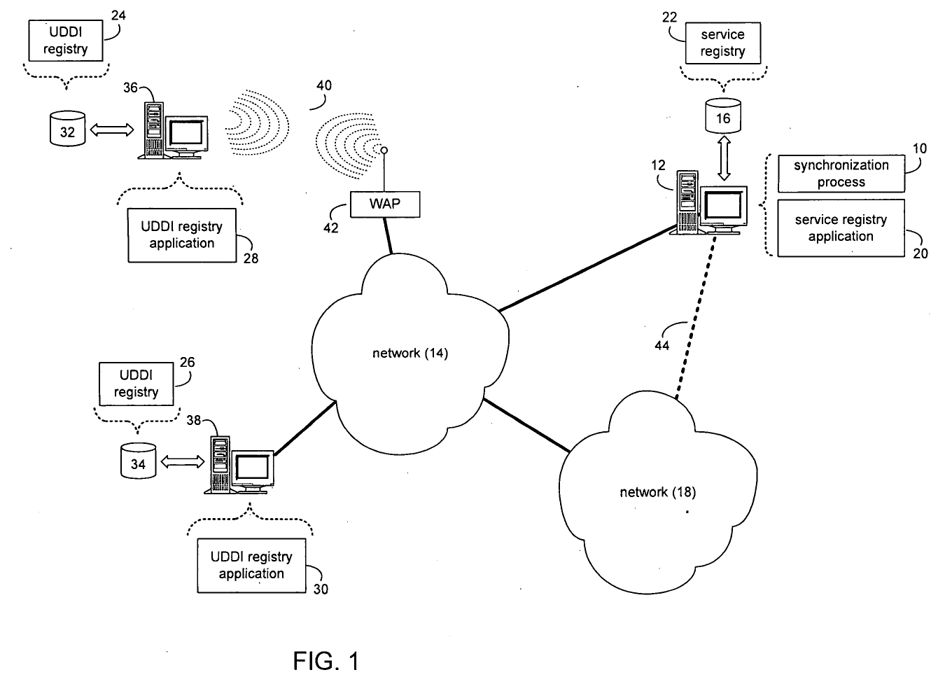

Referring to FIG. 1, there is shown synchronization process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

As will be discussed below in greater detail, synchronization process 10 may query a first UDDI registry for at least one entity contained within the first UDDI registry. At least one attribute of the at least one entity contained within the first UDDI registry may be compared with an entity attribute record associated with a service registry. If the at least one attribute of the at least one entity contained within the first UDDI registry is different from the entity attribute record associated with the service registry, an updated entity attribute record may be generated based upon, at least in part, a difference between the at least one attribute and the entity attribute record.

The instruction sets and subroutines of synchronization process 10, which may include one or more software modules, may be stored on storage device 16 coupled to server computer 12, and may be executed by one or more processors (not shown) and one or more memory architectures (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute service registry application 20, examples of which may include but are not limited to WebSphere® Service Registry and Repository (WebSphere is a registered trademark of International Business Machines Corporation in the United States, other countries, or both). Service registry application 20 may maintain a registry and repository (e.g., in service registry 22 residing on storage device 16) of various types of service documents (e.g., web services, policy documents, XML schema documents, as well as various other documents that may be referenced from a URL). That is, in addition to providing a registry of service documents, service registry 22 may also be a repository, e.g., which may store the service documents in service registry 22. Synchronization process 10 may be a stand alone application that interfaces with service registry application 20 or an applet/application that is executed within service registry application 20.

The instruction sets and subroutines of service registry application 20, which may be stored on storage device 16 coupled to server computer 12 may be executed by one or more processors (not shown) and one or more memory architectures (not shown) incorporated into server computer 12.

Additionally, one or more Universal Description, Discovery and Integration (UDDI) registries (e.g., UDDI registry 24, 26) may be facilitated by, and/or accessible via, one or more UDDI registry applications (e.g., UDDI registry applications 28, 30), examples of which may include, but are not limited to: IBM WebSphere UDDI Registry, Microsoft Windows 2003 Server Enterprise UDDI Services, Novell Nsure® UDDI Server, or the like (Nsure is a registered trademark of Novell corporation in the United States, other countries, or both). UDDI registries 24, 26 may be stored on storage devices 32, 34 (respectively) coupled to server computers 36, 38 (respectively). Similarly, the instruction sets and subroutines of UDDI registry applications 28, 30 may be stored on storage devices 32, 34, and may be executed by one or more processors (not shown) and one or more memory architectures (not shown) incorporated into server computers 36, 38. Storage devices 32, 34 may include, but are not limited to, hard disk drives, solid state drives, optical drives, RAID arrays, random access memories (RAM), read-only memories (ROM), or the like. Examples of server computers 36, 38 may include, but are not limited to: a personal computer, a server computer, a series of server computers, a mini computer, and a mainframe computer. Server computers 36, 38 may be a web server (or a series of servers) running a network operating system, examples of which may include but are not limited to: Microsoft Windows XP Server; Novell Netware; or Red Hat Linux, for example.

UDDI registry applications 28, 30 may allow UDDI registries 24, 26 to be access via network 14 and/or network 18, and thereby allow service documents listed within UDDI registries 24, 26 to be discovered. Server computers 36, 38 may be directly or indirectly coupled to network 14 (or network 18). For example, server computer 38 is shown directly coupled to network 14 via a hardwired network connection. Server computer 36 is shown wirelessly coupled to network 14 via wireless communication channel 40 established between server computer 36 and wireless access point (i.e., WAP) 42, which is shown directly coupled to network 14. WAP 42 may be, for example, an IEEE 802.11a, 802.11b, 802.11g, Wi-Fi, and/or Bluetooth device that is capable of establishing wireless communication channel 40 between server computer 36 and WAP 42. Further, server computer 12 (i.e., the computer that executes service registry application 20) may be connected to network 14 through secondary network 18, as illustrated with phantom link line 44.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

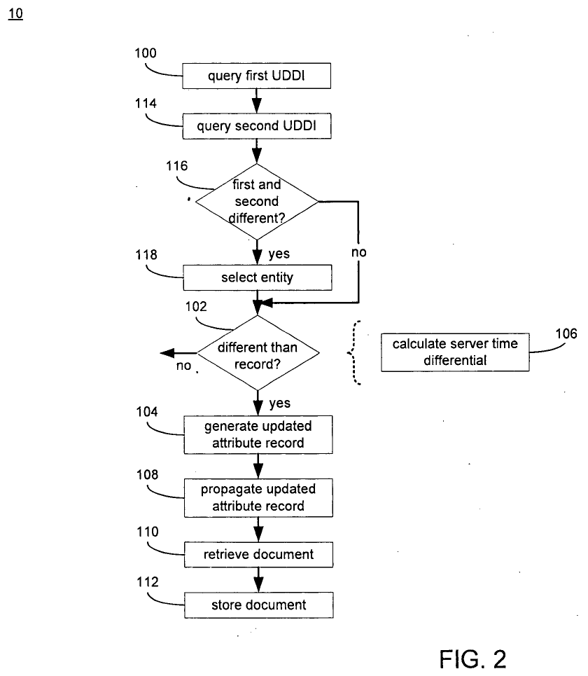

Referring also to FIG. 2, synchronization application 10 may generally allow service documents (hereinafter “entities”) registered in UDDI registries 24, 26 to be discovered and stored in service registry 22 (e.g., may allow synchronization between service registry 22 and one or more of UDDI registries 24, 26). Synchronization process 10 may query 100 at least a first UDDI registry for at least one entity contained within the first UDDI registry. Synchronization process 10 may compare 102 at least one attribute of the at least one entity contained within the first UDDI registry with an entity attribute record associated with a service registry. If the at least one attribute of the at least one entity contained within the first UDDI registry is different from the entity attribute record associated with the service registry, synchronization process 10 may generate 104 an updated entity attribute record based upon, at least in part, a difference between the at least one attribute and the entity attribute record.

For example, synchronization process 10 may query 100 a first UDDI registry (e.g., UDDI registry 24) using a standard UDDI application programming interface (API). Synchronization process 10 may query 100 UDDI registry 24 in response to a user command, according to a predetermined schedule (e.g., at predetermined intervals), or in response to a predetermined event. Querying 100 UDDI registry 24 may be relative to one or more predetermined entities (including a class or group of entities, e.g., which may be parametrically defined) and/or relative to all entities contained within the UDDI registry 24.

Synchronization process 10 may compare 102 at least one attribute of the at least one entity contained within the first UDDI registry with an entity attribute record associated with a service registry. The at least one attribute of the at least one entity contained within the first UDDI registry may include a time of last modification of the at least one entity. Correspondingly, the entity attribute record associated with the service registry may include a time of last modification of a corresponding entity (e.g., an entity corresponding to the at least one entity contained within the first UDDI registry) contained within the service registry.

Continuing with the above-stated example, the entity attribute record associated with the service registry (e.g., associated with service registry 22) may include a file (e.g., an XML file named “ChangedEntityIMG.xml”). The file ChangedEntityIMG.xml may include information pertaining to the last time that various entities contained within service registry 22 were modified. One or more of the entities contained within service registry 22 may correspond to one or more entities contained within UDDI registry 24 (e.g., may be identical to, may represent a previous version of, and/or may represent an updated version of one or more entities contained within UDDI registry 24).

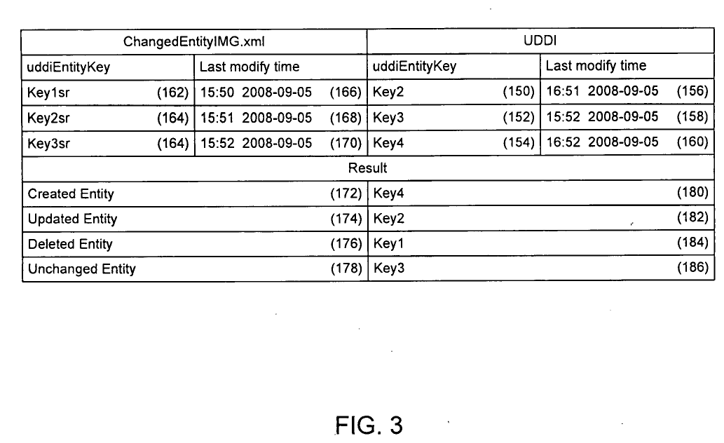

Referring also to FIG. 3, a comparison of a time of last modification attribute of a plurality of entities contained within UDDI registry 24 to a time of last modification from the entity attribute record (including ChangedEntityIMG.xml file) is diagrammatically shown. In the illustrated example, querying 100 UDDI registry 24 may return three entities (namely Key2, Key3, Key4), in UDDI registry entity fields 150, 152, 154, having respective time of last modification attributes (namely 16:51 2008-09-05, 15:52 2008-09-05, 16:52 2008-09-05), in UDDI registry entity last modify time fields 156, 158, 160. The file ChangedEntityIMG.xml of the entity attribute record associated with service registry 22 may include information pertaining to three corresponding entities (namely Key1sr, Key2sr, Key3sr), in service registry record entity fields 162, 164, 166, having respective time of last modification attributes (namely 15:50 2008-09-05, 15:51 2008-09-05, 15:52 2008-09-05), in service registry record last modify time fields 166, 168, 170.

Comparing 102 the last modified time attribute of entities Key2, Key3, Key4 contained within the first UDDI registry (e.g., UDDI registry 24) with the entity attribute record, including last modified times for corresponding entities contained within service registry 22, associated with a service registry may identify one or more Created Entity 172, Updated Entity 174, Deleted Entity 176, and Unchanged Entity 178. Continuing with the above-stated example, UDDI registry 24 may include Key2 (e.g., in UDDI registry entity field 150) having a last modify time of 16:51 2008-09-05. ChangedEntityIMG.xml may indicate a last modify time for the corresponding entity Key2sr contained within service registry 22 as 15:51 2008-09-05. That is, the last modify time attribute of entity Key2 contained within UDDI registry 24 may be an hour later than the last modify time (i.e., indicated in field 168) reflected in the entity attribute record (including the file ChangedEntityIMG.xml) for corresponding entity Key2sr contained within service registry 22. Accordingly, updated entity field 174 may include Key2 as an updated entity in field 182.

In a similar manner the last modify time attribute of entity Key3 contained within UDDI registry 24 may be 15:52 2008-09-05 (e.g., as reflected in last modify time field 158). The last modify time for corresponding entity Key3sr contained within service registry 22 may also be 15:52 2008-09-05 (e.g., as reflected in last modify time field 170). Accordingly, comparing 102 the last modify time attribute of Key3 to the entity attribute record (including the file ChangedEntityIMG.xml) for corresponding entity Key3sr may indicate that entity Key3 contained within UDDI registry 24 is unchanged relative to the corresponding entity Key3sr contained within service registry 22. Accordingly, unchanged entity field 170 may include Key3 as an unchanged entity in field 186.

While the entity attribute record (including the file ChangedEntityIMG.xml) includes a record for the entity Key1sr (e.g., which may be based upon, at least in part a previous synchronization between service registry 22 and at least one UDDI registry, such as UDDI registry 24 or UDDI registry 26), in field 162, querying UDDI registry 24 did not return a corresponding entity Key1. As such, synchronization process 10 may determine that the entity Key1 has been deleted from UDDI registry 24. Accordingly, via comparing 102 at least one attribute of entities discovered by querying UDDI registry 24 to the entity attribute record associated with service registry 22, synchronization process 10 may determine that the entity Key1 has been deleted, as indicted in field 184.

Further, querying 100 UDDI registry 24 may return entity Key4, in entity field 154, e.g., which may not be included in the entity attribute record. Accordingly, by comparing 102 at least one attribute of entity Key4 contained within UDDI registry 24 to the entity attribute record (including the file ChangedEntityIMG.xml), synchronization process 10 may determine that entity Key4 is a newly added (e.g., since the last synchronization event) entity. Accordingly, the entity Key4 may be indicated as a created entity in field 180.

Based upon, at least in part, the differences between the at least one attribute (e.g., the last modify time) of the entities Key2, Key3, and Key4 contained within UDDI registry 24 and the entity attribute record (including the file ChangedEntityIMG.xml) associated with service registry 22, synchronization process 10 may generate 104 an updated entity attribute record. For example, synchronization process 10 may generate 104 an updated ChangedEntityIMG.xml deleting entity Key1, updating entity Key2 having a last modify time of 16:51 2008-09-05, including unchanged entity Key3 having a lost modify time of 15:52 2008-09-05, and including newly created entity Key4 having a last modify time of 15:52 2008-09-05.

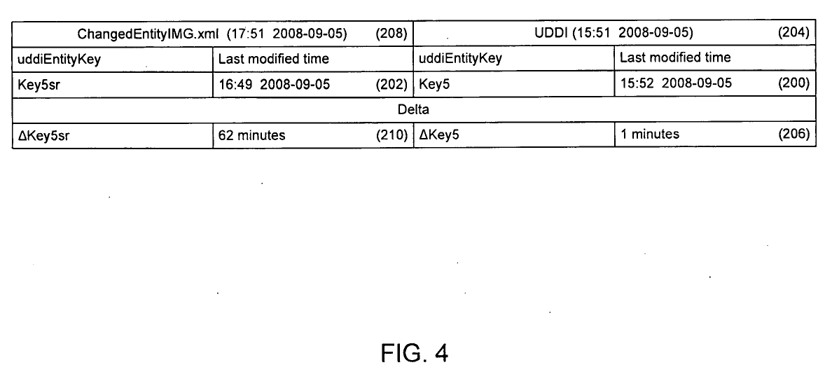

As part of comparing 102 the at least one attribute (e.g., the last modify time) of the at least one entity contained within a first UDDI registry with the entity attribute record associated with a service registry, synchronization process 10 may calculate 106 a server time differential between a time of last modification of the at least one entity contained within the UDDI registry and a time of last modification of the corresponding entity contained within the service registry 22. While in the foregoing examples (including Key1sr, Key2sr, Key3sr, Key2, Key3, and Key 4) it was assumed that the last modify time of the entities contained within UDDI registry 24 and the entity attribute record (including the file ChangedEntityIMG.xml) associated with service registry 22 indicated times within a common time zone, this may not be the case. For example, and referring also to FIG. 4, by querying 100 UDDI registry 24, synchronization process 10 may discover entity Key5 having the last modified time attribute 15;52 2008-09-05, indicated in field 200. Similarly, an entity attribute record (e.g., which may include the file ChangedEntityIMG.xml that may include last change time data for various entities) associated with service registry 22 may include a last modify time attribute for the entity Key5sr (corresponding to entity Key5 contained within UDDI registry 24) of 16:49 2008-09-05, indicated in field 202. Based on the more recent last modified time, the entity attribute record (e.g., including the file ChangedEntityIMG.xml) would appear to reflect a more current status of the entity Key5sr (e.g., which may correspond to entity Key5 contained within UDDI registry 24). However, such a comparison may not take into account time differences based upon, at least in part, different time zone locations of UDDI registry 24 and service registry 22.

Continuing with the above-stated example, synchronization process 10 may calculate 106 a server time differential. For example, synchronization process 10 (alone and/or in conjunction with UDDI registry application 28) may calculate 106 a server time differential by determining the time differential between the current server time at UDDI registry 24 (e.g., 15:51 2008-09-05; indicated in field 204) and the last modified time of entity Key5 (e.g., 15:52 2008-09-05; indicated in field 200), indicating a server time differential of 1 minute (e.g., as indicated in field 206). Further, synchronization process 10 (alone and/or in conjunction with service registry application 20) may calculate 106 a server time differential for service registry 22 (and therefore a server time differential for the entity attribute record) between the current server time at service registry 22 (e.g., 17:51 2008-09-05; indicated in field 208) and the last modified time for entity Key5sr (e.g., 16:49 2008-09-05 as indicated by the entity attribute record and shown in field 202), indicating a server time differential of 62 minutes (e.g., as indicated by field 210). Accordingly, by calculating 106 the server time differential, synchronization process may determine that, while the entity attribute record may indicate a numerically more recent last modified time for entity Key5sr (e.g., 16:49 2008-09-05) as compared to the entity Key5 (e.g., 15:52 2008-09-05), the entity Key5 contained within UDDI registry 24 was more recently modified (e.g., 1 minute ago) than the corresponding entity Key5sr (e.g., 62 minutes ago, as reflected by the entity attribute record including the file ChangedEntityIMG.xml). Various additional and/or alternative mechanisms may also be utilized for calculating 106 the server time differential, e.g., referencing a common time zone, calculating a time offset between servers, etc.

In addition/as an alternative to including a time of last modification, the at least one attribute may include a property of the at least one entity contained within the first UDDI registry, and the entity attribute record may include a property of a corresponding entity contained within the service registry. For example, the entity attribute record associated with service registry 22 may include the file UDDIMG.xml, e.g., which may store properties of entities contained within service registry 22 (e.g., one or more of which entities may correspond to one or more entities contained within UDDI registry 24). As such, comparing 102 at least one attribute of the at least one entity contained within the first UDDI registry with an entity attribute record associated with a service registry may include determining a property of an entity that has changed.

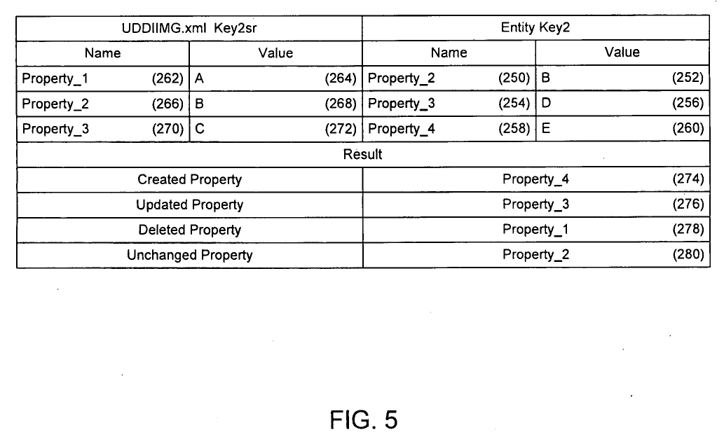

For example, and referring also to FIG. 5, querying 100 UDDI registry 24 relative to the entity Key2 may discover one or more properties of entity Key2 (e.g., property_2, shown in field 250, having a value B, shown in field 252; property_3, shown in field 254, having a value D, shown in field 256; and property_4, shown in field 258, having a value E, shown in field 260). Synchronization process 10 may compare 102 the one or more properties of entity Key2 to one or more properties of Key2sr (e.g., property_1, shown in filed 262, having a value of A, shown in field 264; property_2, shown in field 266, having a value of B, shown in field 268; and property_3, shown in field 270, having a value of C, shown in field 272), which may be included within the entity attribute record associated with service registry 22. Entity Key2 may be an entity contained within service registry 22 that may correspond to entity Key2 contained within UDDI registry 24.

Comparing 102 the properties of entity Key2 and entity Key2sr (as indicated by the entity attribute record associated with service registry 22), synchronization process 10 may determine that property_4 is a newly created property (e.g., as shown in field 274), that property_3 is an updated property (e.g., as shown in field 276), that property_1 has been deleted (e.g., as shown in field 278), and that property_2 is unchanged (as shown in field 280).

Based upon, at least in part, the comparison of the properties of entity Key2 and entity Key2sr (as indicated by the entity attribute record including properties of entity Key2sr), synchronization process 10 may generate 104 and updated entity attribute record. For example, the updated entity attribute record generated 104 by synchronization process may delete property_1 of entity Key2sr from the entity attribute record, update property_3 in the entity attribute record, add property_4 to the entity attribute record, and may leave property_2 unchanged in the entity attribute record.

While the entity attribute record associated with the service registry has been described as including a separate file storing a time of last modification of the corresponding entity contained within the service registry and storing properties of the corresponding entity contained within the service registry this is intended for illustrative purposes only, and should not be construed as a limitation of the present disclosure. For example, information relating to the time of last update and the properties of the corresponding entity contained within the service registry may be included in a single file, may reside in a database, may be included with other information, etc.

Synchronization process 10 may propagate 108 the updated entity attribute record to at least a second UDDI registry. For example, a second UDDI registry (e.g., UDDI registry 26) may include one or more redundant and/or overlapping entities relative to UDDI registry 26. Synchronization process 10 may propagate 108 the updated entity attribute record to UDDI registry 26 (e.g., via the standard UDDI API), such that UDDI registry 24, UDDI registry 26, and service registry 22 all include the same information regarding the commonly registered service documents (e.g., entities). Propagating 108 the updated entity attribute record to UDDI registry 26 may result in the relevant entity entries (including last modified time and one or more properties of the relevant entities) in UDDI registry 26 being updated to reflect the updated attributes.

Additionally, synchronization process 10 may retrieve 110 at least one document referenced by an entity contained within the first UDDI registry. Referring to the above-described examples, entity Key4 may be a newly created (e.g., since the last synchronization event) entity, and entity Key2 may have been updated since the last synchronization event. Synchronization process 10 may retrieve 110 the service documents referenced by entities Key2 and Key4 (e.g., based upon, at least in part, the URL associated with the referenced service documents). Further, synchronization process 10 may store 112 the at least one document in service registry 22, e.g., which as noted by be a repository for service documents.

In addition to synchronizing information from a single UDDI registry, synchronization process 10 may synchronize information from multiple UDDI registries (e.g., from UDDI registry 24 and UDDI registry 26). As such, synchronization process may query 100 a first UDDI registry (e.g., UDDI registry 24) for at least one entity contained within UDDI registry 24, and may query 114 a second UDDI registry (e.g., UDDI registry 26) for at least one entity contained within UDDI registry 26. The at least one entity contained within UDDI registry 24 and the at least one entity contained within UDDI registry 26 may include the same entity, more than one entity defined by a common range or parameter, or the like.

Further, synchronization process 10 may compare 116 at least one attribute of the at least one entity contained within the first UDDI registry (e.g., UDDI registry 24) to at least one attribute of the at least one entity contained within the second UDDI registry (e.g., UDDI registry 26). The at least one attribute of the at least one entity contained within UDDI registry 24 and the at least one entity contained within UDDI registry 26 may include, for example, a last modified time, a property of the entity, or the like. If the at least one attribute of the at leas tone entity contained within UDDI registry 26 differs from the at least one attribute of the at least one entity contained within UDDI registry 24, synchronization process 10 may select 118 one of the at least one entity contained within UDDI registry 26 and the at least one entity contained within UDDI registry 24 based upon, at least in part, a predefined policy. That is, synchronization process 10 may resolve any conflicts that may exist between two or more UDDI registries based upon the predefined policy. In some embodiments, synchronization process 10 may then synchronize a resulting conflict-resolved entity set with service registry 22 (as described herein above).

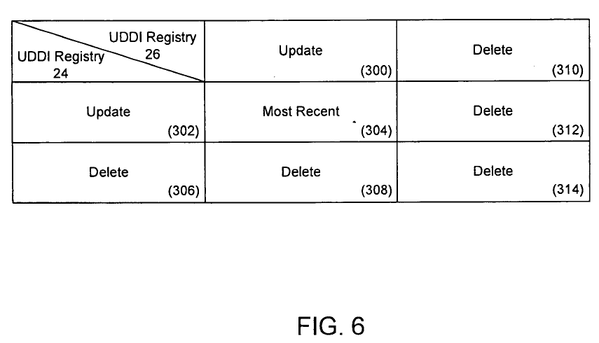

For example, the policy for determining which entity may be selected may be based upon deletion of an entity and last modified time of the entity. According to one exemplary policy, which should not be construed as a limitation on the present disclosure, synchronization process 10 may select 118 the most recently updated entity and/or may delete the entity if it has been deleted (e.g., is not discovered as a result of querying 100, 114 UDDI 24 or UDDI 26) from one of UDDI 24 or UDDI 26. Referring also to FIG. 6, the exemplary policy is diagrammatically illustrated. As shown, if an entity contained within UDDI registry 26 has been updated, in column 300, if a corresponding entity contained within UDDI registry 24 has also been updated, in row 302, synchronization process 10 may select 118 the most recently updated (e.g., latest modified time) entity, in cell 304.

Continuing with the above-stated example, if the entity contained within UDDI registry 26 has been updated, shown in column 300, and the corresponding entity contained within UDDI registry 24 has been deleted, shown in column 306, synchronization process 10 may select 118 the deleted entity (e.g., synchronization process 10 may delete the entity), in cell 308. In a corresponding manner, if the entity contained within UDDI registry 26 has been deleted, in column 310, and the corresponding entity contained within UDDI registry 24 has been updated, in column 302, synchronization process 10 may select the deleted entity (e.g., synchronization process 10 may delete the entity), in cell 312. Further, if the entity contained within UDDI registry 26 has been deleted, in column 310, and the corresponding entity contained within UDDI registry 24 has been deleted, in column 306, synchronization process 10 may select the deleted entity (e.g., synchronization process 10 may delete the entity), in cell 314.

While the description of illustrative embodiments herein-above has utilized tabulated illustrations and description relating to the same, the use of tabulated data and comparisons this has been provided for illustrative purposed only, and should not be construed as a limitation on the present disclosure. The claimed invention may utilize comparisons and calculations that do not necessitate formatting tabulated data and making comparisons and/or calculations based upon such tabulated data.

Having thus described the invention of the present application in detail and by reference to embodiments thereof, it will be apparent that modifications and variations are possible without departing from the scope of the invention defined in the appended claims.

What is claimed is:

1. A method comprising:
querying a first UDDI registry for at least one entity contained within the first UDDI registry;
comparing at least one attribute of the at least one entity contained within the first UDDI registry with an entity attribute record associated with a service registry; and
if the at least one attribute of the at least one entity contained within the first UDDI registry is different from the entity attribute record associated with the service registry, generating an updated entity attribute record based upon, at least in part, a difference between the at least one attribute and the entity attribute record.

2. The method of claim 1, wherein the at least one attribute of the at least one entity contained within the first UDDI registry comprises a time of last modification and the entity attribute record includes a time of last modification of a corresponding entity contained within the service registry.

3. The method of claim 2, further comprising calculating a server time differential between a time of last modification of the at least one entity contained within the first UDDI registry and a time of last modification of the corresponding entity contained within the service registry.

4. The method of claim 1, wherein the at least one attribute comprises a property of the at least one entity contained within the first UDDI registry and the entity attribute record includes a property of a corresponding entity contained within the service registry.

5. The method of claim 1, further comprising propagating the updated attribute record to at least a second UDDI registry.

6. The method of claim 1, further comprising:
querying a second UDDI registry for at least one entity contained within a second UDDI registry;
comparing at least one attribute of the at least one entity contained within the second UDDI registry to at least one attribute of the at least one entity contained within the first UDDI registry; and
if the at least one attribute of the at least one entity contained within the second UDDI registry differs from the at least one attribute of the at least one entity contained within the first UDDI registry, selecting one of the at least one entity contained within the second UDDI registry and the at least one entity contained within the first UDDI registry based upon, at least in part, a predefined policy.

7. The method of claim 1, further comprising:
retrieving at least one document referenced by the at least one entity contained within the first UDDI registry; and
storing the at least one document within the service registry.

8. A computer program product residing on a computer readable medium having a plurality of instructions stored thereon, which, when executed by a processor, cause the processor to perform operations including:
querying a first UDDI registry for at least one entity contained within the first UDDI registry;
comparing at least one attribute of the at least one entity contained within the first UDDI registry with an entity attribute record associated with a service registry; and
if the at least one attribute of the at least one entity contained within the first UDDI registry is different from the entity attribute record associated with the service registry, generating an updated entity attribute record based upon, at least in part, a difference between the at least one attribute and the entity attribute record.

9. The computer program product of claim 8, wherein the at least one attribute of the at least one entity contained within the first UDDI registry comprises a time of last modification and the entity attribute record includes a time of last modification of a corresponding entity contained within the service registry.

10. The computer program product of claim 9, further comprising instructions for calculating a server time differential between a time of last modification of the at least one entity contained within the first UDDI registry and a time of last modification of the corresponding entity contained within the service registry.

11. The computer program product of claim 8, wherein the at least one attribute comprises a property of the at least one entity contained within the first UDDI registry and the entity attribute record includes a property of a corresponding entity contained within the service registry.

12. The computer program product of claim 8, further comprising instructions for propagating the updated attribute record to at least a second UDDI registry.

13. The computer program product of claim 8, further comprising instructions for:
querying a second UDDI registry for at least one entity contained within a second UDDI registry;
comparing at least one attribute of the at least one entity contained within the second UDDI registry to at least one attribute of the at least one entity contained within the first UDDI registry; and
if the at least one attribute of the at least one entity contained within the second UDDI registry differs from the at least one attribute of the at least one entity contained within the first UDDI registry, selecting one of the at least one entity contained within the second UDDI registry and the at least one entity contained within the first UDDI registry based upon, at least in part, a predefined policy.

14. The computer program product of claim 8, further comprising instructions for:
retrieving at least one document referenced by the at least one entity contained within the first UDDI registry; and
storing the at least one document within the service registry.

15. A computing system comprising:
at least one processor;
at least one memory architecture coupled with the at least one processor;
a first software module executed on the at least one processor and the at least one memory architecture, wherein the first software module is configured to query a first UDDI registry for at least one entity contained within the first UDDI registry;
a second software module executed on the at least one processor and the at least one memory architecture, wherein the second software module is configured to compare at least one attribute of the at least one entity contained within the first UDDI registry with an entity attribute record associated with a service registry; and
a third software module executed on the at least one processor and the at least one memory architecture, wherein if the at least one attribute of the at least one entity contained within the first UDDI registry is different from the entity attribute record associated with the service registry, the third software module is configured to generate an updated entity attribute record based upon, at least in part, a difference between the at least one attribute and the entity attribute record.

16. The computing system of claim 15, wherein the at least one attribute of the at least one entity contained within the first UDDI registry comprises a time of last modification and the entity attribute record includes a time of last modification of a corresponding entity contained within the service registry.

17. The computing system of claim 15, wherein the at least one attribute comprises a property of the at least one entity contained within the first UDDI registry and the entity attribute record includes a property of a corresponding entity contained within the service registry.

18. The computing system of claim 15, further comprising a fourth software module executed on the at least one processor and the at least one memory architecture, wherein the fourth software module is configured to propagate the updated attribute record to at least a second UDDI registry.

19. The computing system of claim 15, further comprising:
a fifth software module executed on the at least one processor and the at least one memory architecture, wherein the fifth software module is configured to query a second UDDI registry for at least one entity contained within a second UDDI registry;
a sixth software module executed on the at least one processor and the at least one memory architecture, wherein the sixth software module is configured to compare at least one attribute of the at least one entity contained within the second UDDI registry to at least one attribute of the at least one entity contained within the first UDDI registry; and
a seventh software module executed on the at least one processor and the at least one memory architecture, wherein if the at least one attribute of the at least one entity contained within the second UDDI registry differs from the at least one attribute of the at least one entity contained within the first UDDI registry, the seventh software module is configured to select one of the at least one entity contained within the second UDDI registry and the at least one entity contained within the first UDDI registry based upon, at least in part, a predefined policy.

20. The computing system of claim 15, further comprising:
An eighth software module executed on the at least one processor and the at least one memory architecture, wherein the eighth software module is configured to retrieve at least one document referenced by the at least one entity contained within the first UDDI registry; and
a ninth software module executed on the at least one processor and the at least one memory architecture, wherein the ninth software module is configured to store the at least one document within the service registry.
